(19) United States
(12) Patent Application Publication
(10) Pub. No.: US 2026/0163612 A1
(43) Pub. Date: Jun. 11, 2026

(54) Method And Apparatus For Lens Beamforming

(71) Applicant: Matsing, Inc., Irvine, CA (US)

(72) Inventors: Richard Braithwaite, Irvine, CA (US); Serguei Matitsine, Irvine, CA (US); John Stewart Wilson, Irvine, CA (US)

(21) Appl. No.: 19/028,772

(22) Filed: Jan. 17, 2025

Related U.S. Application Data
(63) Continuation-in-part of application No. 18/926,762, filed on Oct. 25, 2024.
(60) Provisional application No. 63/623,135, filed on Jan. 19, 2024.
(60) Provisional application No. 63/623,135, filed on Jan. 19, 2024.
(60) Provisional application No. 63/729,545, filed on Dec. 9, 2024.

(51) Int. Cl. H04B 7/0413; H01Q 3/46; H01Q 19/06; H01Q 25/00; H04L 5/14

(52) U.S. Cl. CPC H04B 7/0413; H01Q 3/46; H01Q 19/062; H01Q 25/008; H04L 5/14

(57) ABSTRACT

A distributed unit (DU) has a scheduler configured to schedule resource blocks to control a multiple beam network using a lens beamformer. The DU can be independently configured to: schedule resource blocks to dynamically conform to time-of-day demands; grant resource blocks in a multiple UE environment to maximize the use of MIMO layers; associate each use equipment (UE) with a best gNB beam based on the measured power; and to sharing the remaining resource blocks amongst the other UEs whose best beam is active. The multi-beam antenna can use a cat-A RU non-beamforming radio unit (RU). The network can be utilize time division duplexing (TDD) or frequency division duplexing (FDD).

This application is a Continuation-In-Part of U.S. non-provisional application Ser. No. 18/926,762 filed Oct. 25, 2024, which claims priority to provisional application No. 63/623,135 filed on Jan. 19, 2024, and also claims priority to U.S. provisional application No. 63/729,545 filed Dec. 9, 2024. These and all other referenced extrinsic materials are incorporated herein by reference in their entirety.

### FIELD OF THE INVENTION

The field of the invention is wireless antennas, including passive narrow beam antennas using RF lenses.

### BACKGROUND

The following description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Advanced wireless systems (such as “beamforming” systems) include antennas with the ability to scan a narrow beam over the coverage sector. This must be done electronically as air interface standards such as 5G allow for separate beam states thousands of times per second. With demand for data-including video streaming, constant sharing of media rich social media content, and file transfers-ever increasing, more advanced air interface standards include the capability to briefly produce high gain focused beams that either scan or change beam characteristics including position, gain, beam widths, and null and side lobe characteristics based on what the network requires at that time.

This “beamforming” approach typically utilizes multi-element array antennas (i.e. 8×8 element array) in order to produce a single beam which can scan, change in beamwidth (become more narrow or wider) for a given coverage sector depending on what is required at the time. One key advantage of this approach, as opposed to having multiple beams on at the same time for a given coverage area (or a given sector), is the reduced interference from neighboring beams (improved signal-to-noise ratio) this results in higher channel quality index (CQI) and faster through-put for users. Through-put is also increased due to increased gain by having a narrow beam. Such an approach utilizes fewer radio resources (in some cases a single radio) as opposed to having multiple beams on at the same time each using a radio.

These systems use multiple-element arrays to produce the desired beam, they suffer from several drawbacks: limited scanning angle (limited coverage sector), narrow frequency band, beam-width stability, and high power consumption, amongst others. Since such “beamforming” systems use active or passive multiple element phased array antennas, they require all transmitter/power amplifiers to be “on” to form the required beam. This leads to high power consumption regardless of need. To create a narrower beam, more elements in the array are needed to be powered on, this increases power consumption.

The maximum power of the array antenna occurs when all active elements are at maximum power. For a single beam, the direction is controlled by phase shifts within the mapping of a single data stream to the elements. That mapping is a weight set, composed of both amplitude and phase coefficients applied to the array, which is referred to as a precoding matrix in 5G. For maximum array power, the coefficients of the precoding matrix have a constant amplitude with different phase shifts. There is often a desire to taper the amplitude near the edge of the array to reduce sidelobes, but that decreases the maximum power in the boresight direction and widens the beam. The amplitudes of the tapered weights are unity at the center of the array and zero at the edges resulting in a 2 dB loss in maximum array power. This inefficient use of weights requires maximum power of the elements to be over-specified, further increasing the power consumption.

An array antenna can generate multiple beams, but it comes with significant limitations. The beams must share the available power, so at best, the maximum power of the individual beams drops by 10*log 10(Nbeams) where Nbeams is the number of beams transmitted simultaneously. This assumes that the beams are orthogonal. Overlap between neighboring beams reduces the radiation efficiency, resulting in a larger drop in the maximum beam power. The beam power losses and degradations become more pronounced as more beams are added. The maximum element power must be over-specified by a significant margin to accommodate the transmission of multiple beams.

There is a limit to the number of useful beams that can be sent simultaneously by an array antenna. Beams whose boresights have minimal overlap with neighboring beams are desired to minimize interference at the UE being serviced. In general, the number of minimally overlapping beams possible is less than or equal to the number of elements in the array. However, the beams would be orthogonal and equally-spaced. The practical limit on the number of beams used simultaneously is 25% of the number of elements in the array.

There is a fundamental limitation for producing multiple beams in close proximity. If beam directions are too close together, the radiated pattern merges the two beams into one beam with a large width. This is not unlike tapering the precoding coefficients near the edges of the array, which reduces the maximum power available.

Accordingly, there is still a need to provide wireless network beamforming, including 5G beamforming, which does not rely on an array of closely spaced, properly phased, radiating elements.

### SUMMARY OF THE INVENTION

The inventive subject matter provides apparatus, systems, and methods in which wireless network beamforming uses a multiple beam antenna that does not rely on an array of closely spaced, properly phased, radiating elements. One embodiment, but not the only possible embodiment, is an RF lens based multiple beam antenna where each beam is associated with a single radiating feed.

RF lens-based antennas (single or multiple beam) provide several performance advantages compared to traditional multi-element array antennas. These include consistent pattern performance over azimuth and elevation (wide scanning angle), high isolation between beams, and consistent performance over wide frequency range. Certain types of RF Lens antennas (such as those utilizing single Luneburg lens and others) have no (or very minimal) scan loss and no, or very minimal, grating lobes. Scan loss in traditional scanning antennas (such as multiple element array) results in gain loss and wider beams. Grating lobes typically severely degrade multiple beam antenna performance outside a restricted scanning range as they cause interference and reduce signal-to-noise ratio. The side lobes of the RF lens antenna are low by design, typically 4-6 dB lower than the equivalent multiple element array.

RF lens based multiple beam base station antennas have seen increasing use in wireless networks in the past decade. Used both outdoors in macro cells and outdoor venues and indoor in large convention halls and sports venues, the typical arrangement is that each set of beams in a given direction represents a sector and a radio designed for either 2 or 4 input/output ports is connected to each beam set. In the case of 4 port radios two sets of dual polarized antenna beams aligned for the same coverage are used, typically by stacking two identical lenses horizontally or vertically. As such they are primarily used as multiple-beam antennas which have multiple beams “on” or active at the same time (each beam with its own radio).

RF lens based multiple beam antennas are typically not used for beam scanning antennas (beam forming) like those used in some 5G air interface standard implementations because such implementations have been designed to work with multiple element array antennas to create the necessary beam(s) as required by the network, whereas RF lens antennas have multiple fixed beams created using an RF lens. For this situation an RF lens solution could work if a network feature is added to reverse the beam forming function either by hardware, software, or a combination of hardware and software. Taught here is the concept of reverse beam former (RBF). Three possible hardware RBF embodiments taught here include a butler matrix, a Rotman lens and a novel parallel plate approach.

For a set of fixed beams, the RF lens has a distinct advantage over the array antenna. The beams have different feeds with a single power source for each beam transmitted simultaneously. There is no reduction in maximum power for a beam in a multiple beam application compared to a single beam application. UEs at the cell edge can be serviced simultaneously with nearby UEs on different beams requiring high throughput.

The RF lens approach and array antenna approach have different characteristics with respect to throughput, coverage, and capacity. The array antenna can have multiple beams supporting independent 5G layers, but the maximum transmitted power per beam drops. High capacity is possible if all the UEs are near the gNB. This can be viewed as an undesired shrinkage of the cell coverage. To service a UE near the cell edge, a single beam must be used to get enough power, which prevents any UEs on different beams from being serviced at the same time. This is a limitation of the array antenna, but not the lens beamformer that powers each beam independently.

Beamforming, in general, involves the selection of the beam to best service a UE. In 5G, it is done based on downlink channel estimates, where channel refers to the air interface between the antennas of the gNB and UE. Codebook-based feedback is used as an option in 5G to provide channel state information (CSI). The codebook reduces the overhead of the feedback by sending the index of the dominant beam, which the UE estimates using CSI reference signals sent by the gNB and information about the array antenna. The codebook is optimized for array antennas, introducing a discrete Fourier transform (DFT) operation to convert received CSI-RS into beam directions.

A fixed multiple beam antenna solution needs to be compatible with the 5G system. The DFT is not required but it is done by the UE as part of the 5G specification. This presents a compatibility issue.

Parent application Ser. No. 18/926,762

Parent application Ser. No. 18/926,762 ('762 application) discloses apparatus, systems, and methods to solve the limitations in a traditional multiple-element-array beamforming system (narrow scanning angle, narrow band, high grating lobes, high power) by adapting the system to work with an RF lens (or any other passive multiple beam antenna) instead of a traditional multi-element-array. Several methods are introduced including adaptation through hardware (by introducing a reverse-beam-forming network in combination with traditional beam forming radios), as well as adaptation through software (through configuring a processor to interface/work with standard radio heads and a RF lens antenna to deliver beam-forming functionality).

Among other things, the '762 application proposes methods to make codebook feedback compatible with lens beamforming without changing the UE. The approach modifies the CSI reference signals sent by the gNB to compensate for the unnecessary DFT operation.

One such approach is where a standard RF lens antenna is used with one of several RBF networks which can be passive networks that connect to beam forming radios. In this instance a beam-forming radio, designed to work with a beam-forming network (BFN) and a multiple-element-array, can be instead connected to an RBF network and an RF lens to produce Lens Beam Forming (LBF).

In one embodiment separate beams can be created by the RF lens as beams of a scanning array and adapt network beam selection approaches that use typical N×M beam forming networks (BFNs) to work in reverse compared to their usual implementation. This allows for beam-forming radios to be used with “Reverse Beam Forming Networks” and an RF Lens (instead of beam forming radios being used directly with a multiple-element array) to provide the same functionality but with the added advantages of having a RF Lens instead of an array.

Approaches to achieve lens beam forming include using software configuration, hardware configuration, or both, such that a processor (i.e. baseband unit) can interface with standard radio heads to deliver beamforming functionality without having to use a multi-element array. This approach for use in applications including 5G beam scanning (and beamforming) uses traditional 4×4 radio units and configures the base band processing unit to route signals to the beam required for signaling broadcast and active state user equipment (UE). Allowing a RF lens antenna to have scanning and beam forming capabilities and providing the benefit of having wider scanning angle (able to cover wider sector), wider frequency range and potentially less power consumption than a traditional multi-element array antenna beamforming system.

In terms of power consumption, a key advantage to using an RF lens antenna for lens beam forming is the beams are formed passively (on only when they need to be on) and provide a much lower power consumption option compared to traditional phased array beamforming. How narrow of a beam does not impact power consumption when using a RF lens antenna (or other passive multiple beam antenna), only the beam needed at a given time uses power. This is a key advantage over beam-forming multi-element array system where to create a narrower beam, more elements are needed to be powered on in the array (to create a larger aperture and thus narrower beam) and as such use more power. The narrower the beam, the more power, whereas with the proposed solution, regardless of how narrow your beam, only that one beam is “on” at a time thus greatly reducing power consumption.

Further key advantages include the ability to dynamically add capacity when needed. Such a system can easily be scaled to allow for multiple or single radio depending on capacity requirements. This allows the same antenna system to operate multiple radios dynamically (can have single beam with single radio on, or multiple beams each with own radio on).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a diagram of a prior art 5G base station (gNB) and user equipment (UE) connected by a RF channel.

FIG. 2 is a diagram of a prior art 5G O-RAN system showing the split between the distributed unit (DU) and radio unit (RU).

FIG. 3 is a diagram of a prior art array antenna with radiating elements having two polarizations (pol).

FIG. 4 is a diagram of a prior art lens beamformer with radiating elements having two polarizations (pol).

FIG. 5 is a diagram of a prior art 8T8R RU.

FIG. 6 is a diagram of a prior art non-beamforming RU and a prior art beamforming RU.

FIG. 7 is a diagram of prior art beamforming using an array antenna with a single beam transmitting a single data channel s₁.

FIG. 8 is a diagram of a prior art fixed set of beam directions.

FIG. 9 is a diagram of a prior art beam sweep for an 8T8R system with 4 beams over a 120-degree sector single active beam (both polarizations).

FIG. 10 is a diagram of a prior art beam sweep where a sector is split into two parts using a 16T16R lens beamformer with 8 beams.

FIG. 11 is a diagram of prior art system in which two beams are transmitted simultaneously in a sector.

FIG. 12 is a diagram of a prior art resource block and slots.

FIG. 13 is a diagram of a prior art resource block with 2 layers.

FIG. 14 is a diagram of a prior art full rank SU-MIMO example with three RF channels.

FIG. 15 is a diagram of beam sweep, where all resource blocks within a given slot are assigned to the same beam.

FIG. 16 is a diagram depicting simultaneous scheduling of two orthogonal beams using a resource block.

FIG. 17 is a diagram depicting simultaneous scheduling of two orthogonal beams using 2-layer MIMO.

FIG. 18 is a diagram of a beam pattern having a grey zone with a reduced power level compared to the boresight direction.

FIG. 19 is a diagram of a beam pattern where neighboring beams are used to reduce grey zone degradation.

FIG. 20 is a diagram of a beam pattern where a third and fourth beams are added to further reduce grey zone degradation.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

In the following description, a base station in 5G is referred to as a gNB and a mobile device is referred to as user equipment (UE). In a 5G O-RAN system, the gNB includes a distributed unit (DU) that transmits and receives digital data through several radio units (RUs), which are also part of the gNB. The RU connects to antenna (ANT) ports that have radiating elements transmitting and receiving signals to/from UEs within the cell.

As used herein the term “O-RAN” refers to an Open Radio Access Network (O-RAN) is a disaggregated approach to deploying mobile fronthaul and midhaul networks built entirely on cloud native principles. As described in https://www.5g-networks.net/openran-o-ran-for-5g-explained/, O-RAN is an evolution of the Next Generation RAN (NG-RAN) architecture, first introduced by the GSMA's 3GPP in their release 15 (5G version 1) technical specification TS 38.401. The O-RAN Alliance formed to undertake the advancement of NG-RAN philosophies, expanding on the scope of what was originally outlined by the 3GPP. Comprising over 1601 member companies, the O-RAN alliance issues specifications and releases open source software under the auspices of the Linux Foundation.

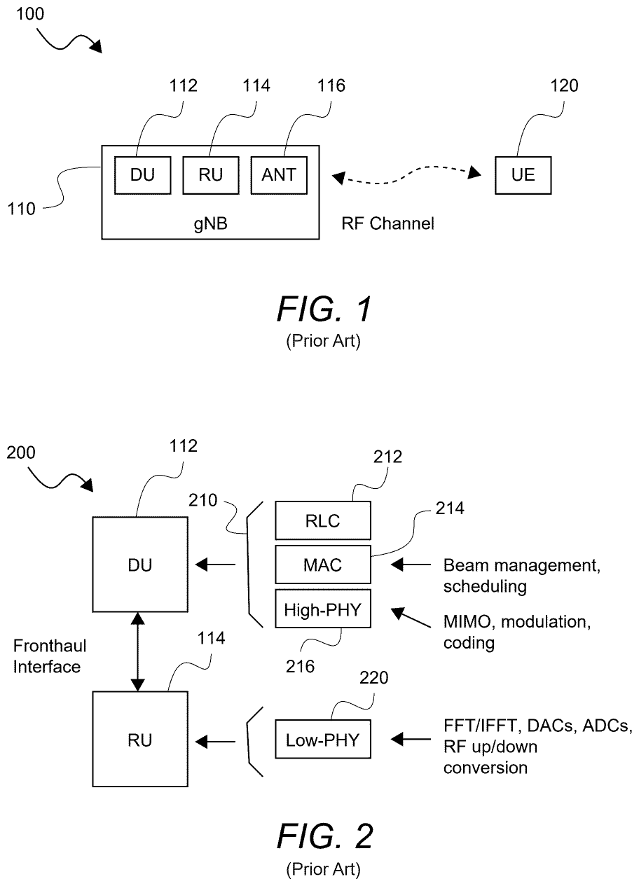

FIG. 1 is a block diagram 100 of a gNB 110, whose key components are a DU 112, a RU 114, and an ANT 116, communicating with a UE 120 over a RF channel. Discussion herein focuses on interactions of the DU, RU, and ANT needed to perform beamforming within a fixed multiple beam network.

In FIG. 2 is a detailed block diagram of an 5G O-RAN system 200 having a split between the distributed unit (DU) 112 and the radio unit (RU) 114. The functional split between the DU 112 and RU 114 is referred to as a fronthaul interface. Fronthaul channels move data between the DU 112 and RU 114. The DU 112 contains multiple components 210 including the RLC 212, MAC 214, and high PHY 216. The high PHY 216 includes MIMO, modulation, and coding. The MAC 214 includes scheduling and beam management. The RU 114 contains the low PHY 220, which includes FFT/IFFT, DACs, ADCs, and RF up and down conversion. The RU 114 converts digital data to RF signals in the downlink (DL) and RF signals to digital data in the uplink (UL).

There are two types of beamforming antennas: array antenna and lens beamforming antenna where the former is most common in 5G.

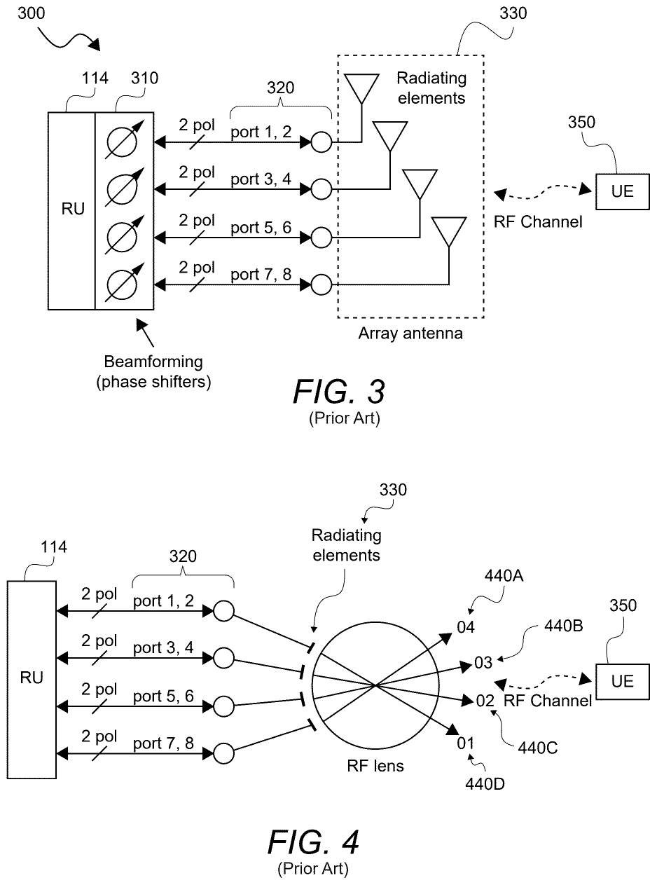

FIG. 3 depicts a prior art array antenna system 300 and user equipment 350. The array antenna system 300 includes a radio unit 114, phase shifters 310, ports 1-8 320, and radiating elements 330 with two polarizations (pol) 320, using ports 1-8 320. The radiating elements 330 are spaced evenly along a line or across a plane in two dimensions. Beams are formed by creating phase gradients between elements, which correspond to boresight directions.

In FIG. 4 a lens beamformer uses a RF lens with components from FIG. 3 to create beams 440A, 440B, 440C and 440D by focusing radiated RF power from the dual polarized elements 330 in a boresight direction. The radiating elements 330 are placed in an arc near the spherical or perhaps cylindrical lens to create the beams 440A, 440B, 440C and 440D, typically spaced evenly over the azimuth direction.

A beamforming system can be implemented in either a time division duplex (TDD) or frequency division duplex (FDD) environment. An array antenna is better suited for TDD than FDD because the phase gradients in the precoder, used for controlling the beam direction, change with frequency. Since a TDD system uses the same frequency band for the uplink and downlink, it is not a serious limitation. For FDD, the uplink and downlink use different frequency bands, making the phase gradients different for the transmit precoder and receiver vector weights, which means channel reciprocity is not valid. In contrast, a lens beamformer defines a beam direction by the placement of the antenna element along an arc, which is less dependent on frequency. As a result, some channel reciprocity exists in terms of beam direction for the lens beamformer in a FDD environment that does not exist for an array antenna beamformer.

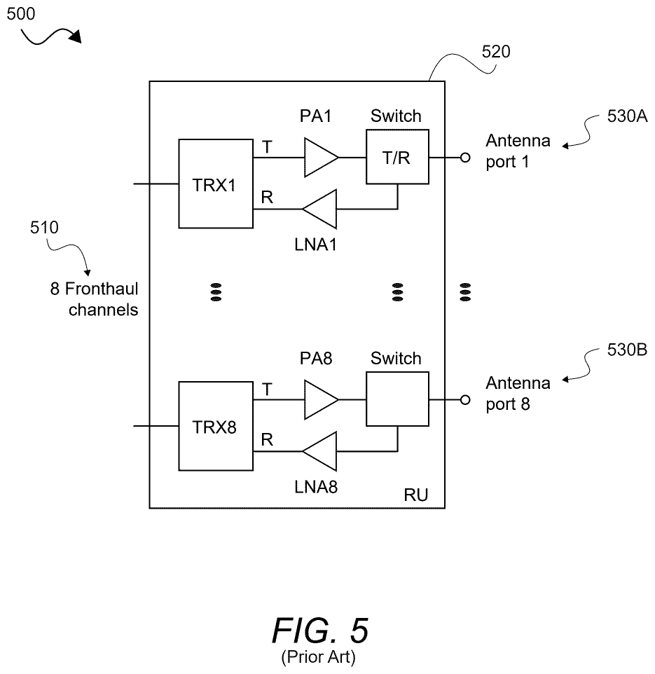

In FIG. 5, a system 500 includes a RU 520 with eight RF ports, ports 530A . . . 530B, and using fronthaul channels 510, and available for transmitting (T) and receiving (R). If four RF ports are present it is referred to as 4T4R. Eight ports is referred to as 8T8R. Within the RU 520 are transceivers (TRX) that convert digital to RF for transmission and RF to digital for reception. A power amplifier (PA) increases the RF power level of the transmitted signal and a low noise amplifier (LNA) increases the power level of the received signal. The antenna ports 530A . . . 530B share both transmit and receive signals. In a TDD system, a transmit/receive (T/R) switch within the RU selects which path is connected to the antenna port. Alternatively, a TDD system may a use a circulator within the RU to route the transmit and receive signals to/from the antenna port. For a FDD system, a duplexer is used to separate the transmit and receive signals within the RU.

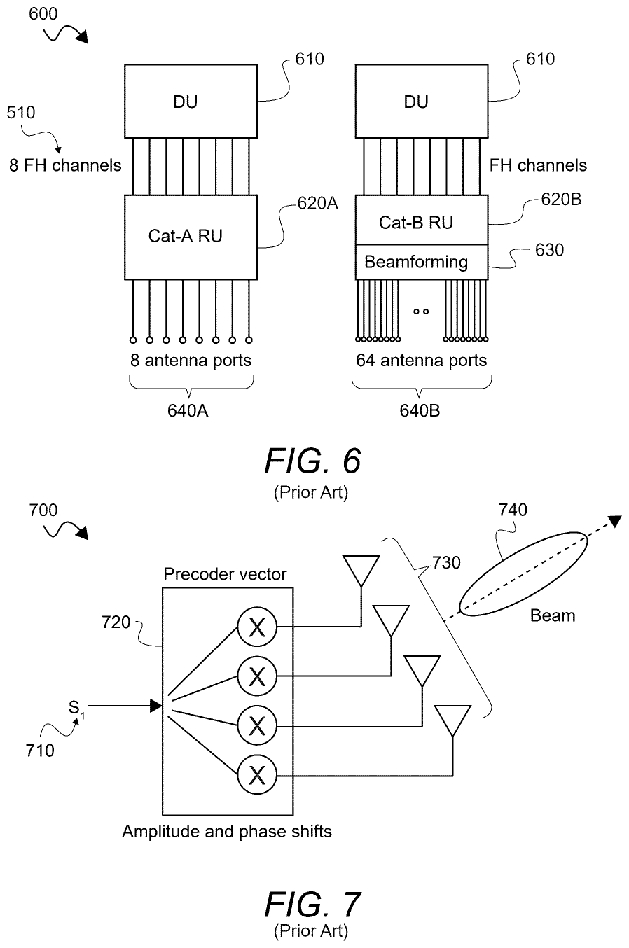

FIG. 6 is a diagram 600 showing a prior art non-beamforming RU 640A and a prior art beamforming RU 640B. The non-beamforming RU 640A, referred to as a Cat-A split, has a maximum of 8 fronthaul (FH) channels 510 between the DU 610 and the RU 620A. The fronthaul channels correspond to 8 antenna ports 640A because the precoding, used in MIMO and beamforming, is done in the DU. The beamforming RU 640B, referred to as Cat-B, assumes that an array antenna is used, which can have as many as 64 antenna ports 640B. A fronthaul channel from the DU 610 is mapped within the RU 620B to the available antenna ports 640B using the appropriate beamforming phase shifters 630 to steer the beam in the desired directions. This is the precoding for beamforming, which is done in the RU. The beamforming functionality of the Cat-B RU reduces the number of fronthaul channels required between the DU 610 and RU 620B. Each fronthaul channel corresponds to a beam and polarization rather than an antenna port.

In the system 700 of FIG. 7, a single beam 740 is transmitted from all antenna elements 730 using precoder vector 720 receiving signal from single data channel s₁ 710. All antenna ports differ only by amplitude and phase shifts using the precoder vector 720.

A lens beamformer does not require the RU to have beamforming functionality because the lens does the beamforming. Each antenna port corresponds to a beam and polarization, which is compatible with the Cat-A split. A 4T4R system creates two beams each with two polarizations and 8T8R creates 4 beams and two polarizations. The non-beamforming RU (Cat-A) with a lens beamformer obtains the benefits of beamforming without the added complexity of a Cat-B RU.

To make beamforming effective, a fixed set of beam directions 810, 820, 830, 840 is defined as shown in

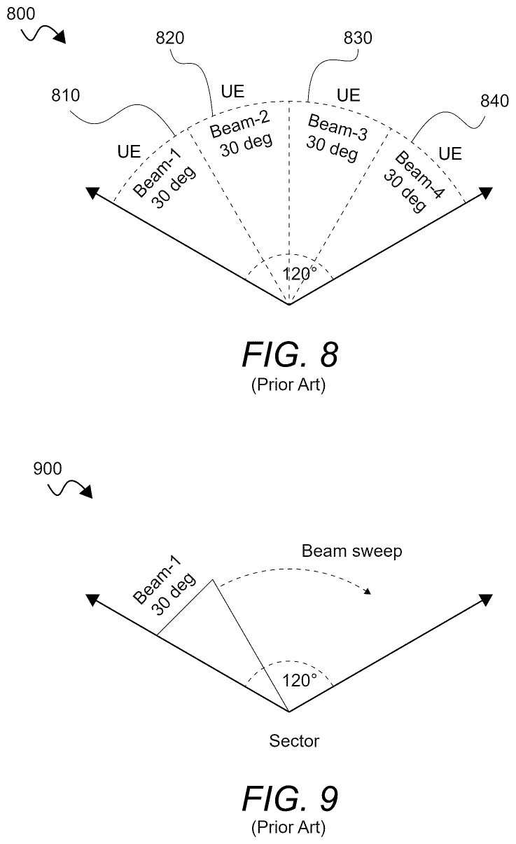

FIG. 8 shows a beam pattern 800 with a number, Nbeams, of fixed beam directions 810, 820, 830, 840. It is not necessary that all be used simultaneously. It is preferable that the beams transmitted simultaneously be orthogonal to each other to minimize cross-beam interference. Creating beams with narrow beam widths is desired, where the width is roughly the same as the spacing between neighboring beam directions. In some cases, the defined set of beam directions is oversampled compared to the beam width to intentionally create overlap, but the active beams are selected to maintain sufficient spacing to limit overlap.

The beam width is roughly defined as the width of the main lobe of the antenna's radiation pattern. Side lobes are considered undesirable because of leakage into the main lobes of neighboring beams. The main and side lobes for a spherical lens antenna are controlled by the design of the lens. A larger sphere creates a narrower beam width. Improved reduction of side lobes is possible and is beneficial to minimize overlap between active beams.

For beams formed by an array antenna, the width of the main lobe decreases with the number of antenna elements, Nₐₙₜ. However, side lobes overlap with the main lobe of neighboring beams. Tapering the antenna elements, where RF signals at ports near the edge of the array are attenuated within the precoder, reduces side lobes, but increases the width of the main lobe. The main problem is that the number of elements Nₐₙₜ becomes large for a narrow beam width making Nₐₙₜ>>2·N_{beams}. The motivation for having beamforming functionality in the RU is to reduce the number of fronthaul channels between the DU and RU to 2·N_{beams}.

An approach used in 5G is to sweep a single active beam (both polarizations) over the available directions, as shown in the beam pattern 900 FIG. 9. Each beam direction is visited sequentially over time to cover the entire sector. A single active beam does not experience cross-beam interference. A narrow beam increases the power received at the UE, which improves throughput. The downside of the single beam sweep is that a UE must wait until its beam is active before being scheduled for data transfers. This reduces the maximum throughput for a given UE by a factor of 1/N_{beams}.

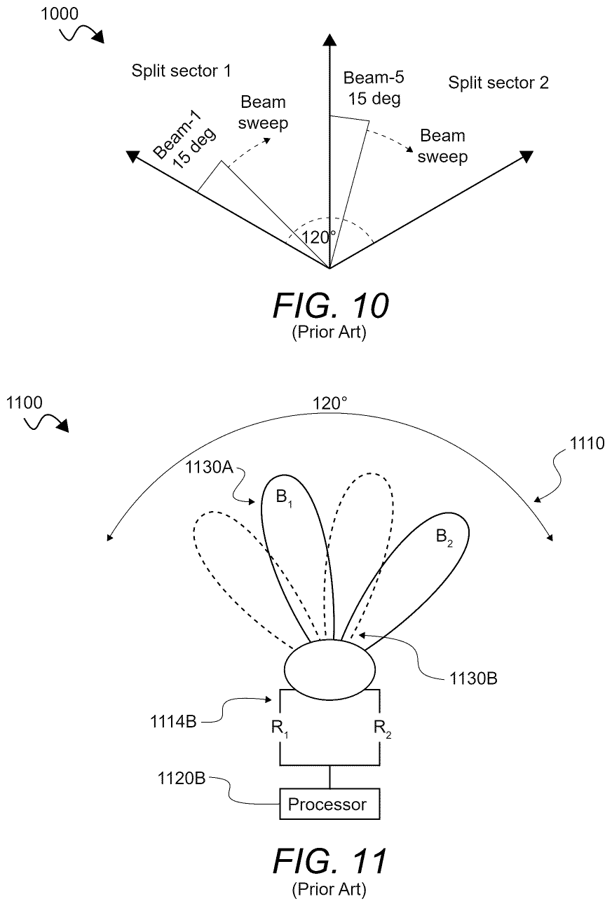

Consider a lens antenna with 16T16R, which has 8 beams and 2 polarizations. It is possible to split the available beams between two sectors, as shown in beam pattern 1000 of FIG. 10, where each sector has a separate 8T8R RU. If there is minimal overlap between sectors, one beam per sector can be transmitted simultaneously, doubling the throughput of the cell. The throughput to a given UE improves because there are 4 beams in the split sector sweep instead of eight, giving the UE more frequent scheduling opportunities. Synchronization of the two sweeps helps to reduce beam overlap. This is possible when the two RUs share the same DU.

A sweep using two or more beams is difficult to perform using an array antenna. Side lobes and grating lobes cause isolation problems making it difficult to avoid beam overlap even with synchronization of the sweeps. In addition, an array antenna has power limitations because the maximum total transmitted power is fixed meaning that the power per beam drops as more beams become active. The lens beamformer does not experience the same power limitations because each beam/polarization is powered by separate PAs or LNAs.

It is possible to transmit two beams 1130A, 1130B simultaneously within a sector 1110, as shown in the beam pattern 1100 of FIG. 11. The two beams 1130A, 1130B are operated by processor 1120B and radios R1 and R2, 1114B. respectively. This increases capacity if multi-user (MU) MIMO or single user (SU) MIMO is possible, where two or more layers per beam/polarization re-use resource blocks. If MIMO is not possible, the two beams must the share the available resource blocks to minimize interference, limiting throughput gains.

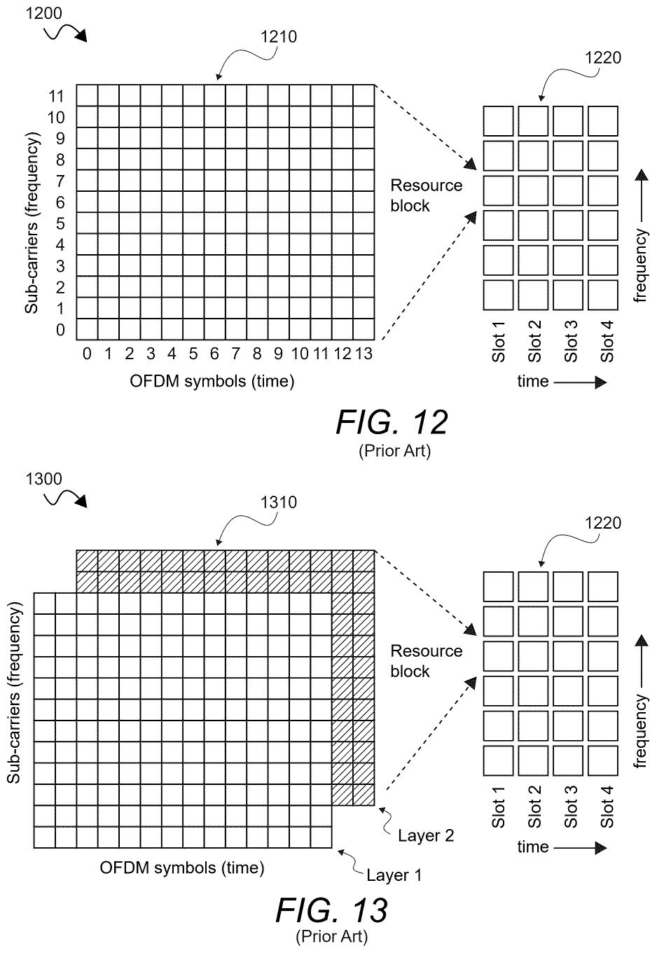

The waveform used in 5G is based on OFDM. An OFDM symbol spans a time interval and has several sub-carriers that span the allocated bandwidth (BW). A slot is defined as 14 symbols that spans 1 ms when the sub-carrier spacing (SCS) is 15 kHz. Diagram 1200 of FIG. 12 shows a resource block (RB) 1210, which is one of many resource blocks in a grid spanning multiple slots 1220. Here, resource block 1210 is defined as 12 sub-carriers and N_{sym} symbols, where N_{sym}=14 is typical. The resource block is the smallest unit that the scheduler within the DU uses for DL and UL grants to a given UE.

When multiple UEs are present within a sector, the scheduler determines how the available resource blocks are shared. In the simplest case, a resource block is assigned to one UE. Since the resource blocks are orthogonal to each other, an individual UE can obtain a signal free of interference from the gNB, although added noise and interference will appear at the UE from other sources.

The wireless connection between the gNB and the UE can produce several independent RF channels if certain conditions are met. Consider the downlink. If the gNB has Nₐₙₜ transmitting elements and the UE has Mₐₙₜ receiving elements, it is possible to form independent channels where the number is the lesser of Nₐₙₜ and Mₐₙₜ. Channel estimation is used to determine which of the possible channels are good enough to support independent data transfers given the noise and interference at the UE. A channel matrix captures the pair-wise coupling between the transmit elements in the gNB and the receive elements in the UE.

Where more than one feasible RF channel exists, and MIMO processing can be used. In FIG. 13, a resource block 1310 is allocated to two or more RF channels (with independent data), which is one of many resource blocks in a grid spanning multiple slots 1220. This is referred to as layers in 5G, and shown here as layers 1 and 2. If two or more layers are allocated to the same UE, it is referred to as SU-MIMO. If layers are allocated to different UEs in the sector, it is referred to as MU-MIMO. SU-MIMO is limited to 4 layers. The combination of SU- and MU-MIMO is limited to 16 layers; however, in practice it is rare to exceed 8 layers.

The benefit of using additional layers is that the capacity of the sector increases. For a single layer, capacity is BW·log₂{1+SINR}, where SINR is the signal to interference plus noise ratio. For multiple layers, the total capacity becomes the sum of the individual layer capacities. Adding layers tends to reduce the SINR of individual channels meaning it is not obvious what is the best number of the layers. The reduction in SINR may be due in part to the RF channels not being fully orthogonal in practice. For an array antenna, a further SINR reduction occurs because the maximum total transmitted power remains constant causing the per layer power to drop. In contrast, each beam/polarization in a lens beamformer system is driven by a separate power amplifier for the downlink meaning the power per layer remains constant (total power transmitted increases). The lens solution also has separate LNAs for beams/polarizations in the uplink.

Consider the downlink. For an array antenna, the RF channels are defined by the left and right eigenvectors of the channel matrix. There is a distinct eigenvector pair (left, right) for each RF channel. The precoder matrix in the gNB transmit path applies weights to the RF signals based on the right eigenvectors before reaching the antenna ports. The left eigenvectors determine the receiver weights in the UE. The quality of a channel is determined by its respective eigenvalue. The largest eigenvalues are considered dominant and the number of them selected is referred to as the MIMO rank. The dimensions of the precoder matrix are determined by the MIMO rank (number of layers used) and the number of gNB antennas.

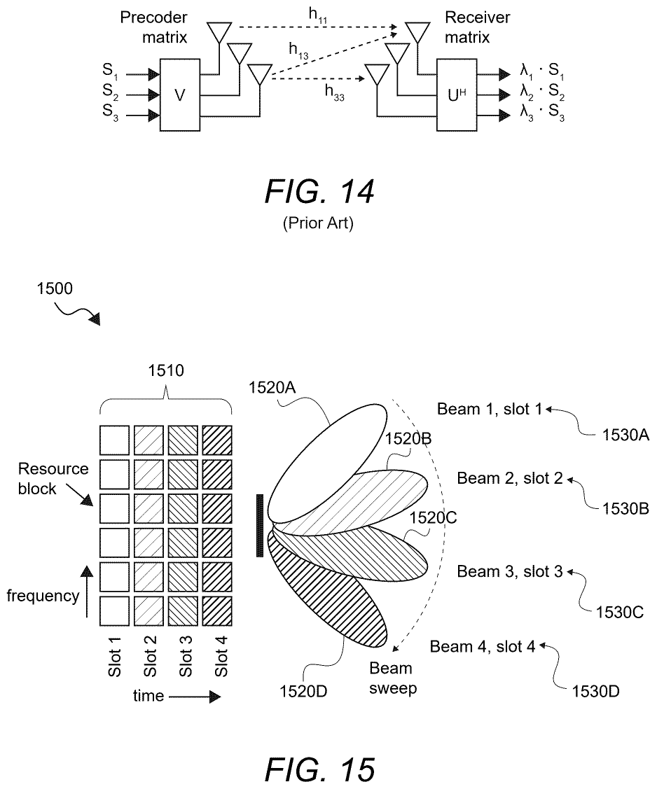

FIG. 14 shows a full rank SU-MIMO example with three independent RF channels. The channel matrix is denoted by H, the right eigenvector matrix is denoted by U, the left eigenvector matrix is denoted by V, and Λ is a matrix with eigenvalues λₙ along the diagonal.

The channel matrix His

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

where hₘₙ is the coupling between receive antenna m and transmit antenna n. The singular value decomposition (SVD) of His

$$H = U \cdot Λ \cdot {V}^{H}$$

where Λ(m,n)=λₙ if m=n and 0 if m≠n; U and V are the left and right eigenvector matrices. The right eigenvector matrix V is composed of columns of eigenvectors,

$$V = [ {\underline{v}}_{1} {\underline{v}}_{2} {\underline{v}}_{3} ]$$

where vₙ is the right eigenvector of H associated with channel n. Note that V^{H}V=I (identity matrix) and V^{H}·v₁=[1 0 0]^{T}. Similar properties hold for the left eigenvectors in U.
The coupling between transmit and receive antennas can be written as

$${\underline{y}}_{RX} = H \cdot {\underline{x}}_{TX}$$

where x_{TX} is the vector of RF signals at the transmit antennas and y_{RX} is the vector of RF signals at the receive antennas. The transmit data vector is denoted by x=[s₁ s₂ s₃]^{T}, where sₙ is the data transmitted on channel n. The receive data vector is denoted by y. A precoder matrix V is applied to the transmit data vector x to get

$${\underline{x}}_{TX} = V \cdot \underline{x}$$

The signal at the receive antennas becomes

$${\underline{y}}_{RX} = U \cdot Λ \cdot {V}^{H} \cdot V \cdot \underline{x} = U \cdot Λ \cdot \underline{x}$$

Applying the matrix U^{H} to the receive vector, we get

$$\underline{y} = {U}^{H} \cdot U \cdot Λ \cdot \underline{x} = Λ \cdot \underline{x}$$

which makes y=[λ₁s₁ λ₂s₂ λ₃s₃]^{T}, successfully decoding three independent data signals where each received signal is weighted by the respective eigenvalue λₙ.

If only one MIMO channel is used, which is considered rank 1, x_{TX}=v₁·s₁, where the dominant right eigenvector v₁ is used as the precoder. The receive vector becomes y_{RX}=U·Λ·[1 0 0]^{T}·s₁. Applying the corresponding dominant left eigenvector u₁ to the receive vector, we get y=u₁^{H}·U·Λ·[1 0 0]^{T}·s₁=λ₁·s₁. The data s₁ is decoded successfully by the UE receiver with a weight of the dominant eigenvalue λ₁.

The precoder matrix can also be used for defining beam directions when using array antenna beamforming. The sub-space spanned by the dominant right eigenvectors can often be approximated by beam directions and polarizations. In such cases, multiple layers can be applied successfully within a beamforming system. The use of dual polarization antenna elements usually guarantees that at least two SU-MIMO layers are possible under beamforming. Note that the precoding for beamforming is applied within the DU for a Cat-A split and within the RU for a Cat-B split.

For a lens beamforming system, the lens is considered part of the channel matrix. Although the precoder matrix can be based on the dominant right eigenvectors, the precoder is often approximated adequately by the selection of active beams that are approximately orthogonal. That is, the precoder matrix is approximately equal to a matrix having one non-zero element in each column.

The beam directions are predefined for a lens beamformer. It is advantageous to oversample the beam spacing so that selected beams are a closer match to the dominant right eigenvectors, which typically includes the line-of-sight direction to the UE. When the line-of-sight to the UE falls between the available beam directions, the UE is said to be in a grey zone. Oversampling the beam spacing reduces the severity of grey zones.

Measurements of the downlink channel are done in the UE based on known CSI reference signals transmitted by the gNB. Feedback from the UE in the form of a CSI report provides the gNB with parameters such as the channel quality indicator (CQI), precoding matrix indicator (PMI), rank indicator (RI), CSI-RS resource indicator (CRI), and layer 1 reference signal received power (L1-RSRP). The PMI is useful for MIMO and beamforming towards a specific UE. The CRI and L1-RSRP are useful for selecting the beam that best services a UE when a predefined set of gNB beam directions is used. This is referred to as beam management in 5G. An alternative method of estimating downlink parameters for a TDD system is to assume RF channel reciprocity and use uplink information, such as the SRS.

Consider the conditions needed to allow downlink MU-MIMO where the gNB transmission is received by two UEs, denoted by UE1 and UE2. Let the channel matrices be denoted by H_{UE1} and H_{UE2}, respectively. The right eigenvector matrices for UE1 and UE2 are V_{UE1} and V_{UE2}. The eigenvalue matrices are Λ_{UE1} and Λ_{UE2}. Assume there are two independent data channels, s₁ and s₂, as well as two precoding vectors p₁ and p₂, used in a 3×3 MIMO example as in FIG. 14.

The receive data vector for UE1, denoted by y_{UE1}, is

$${\underline{y}}_{UE 1} = {Λ}_{U E 1} \cdot {V}_{U E 1}^{H} \cdot [ {\underline{p}}_{1} {\underline{p}}_{2} ] \cdot [ \begin{matrix}{s}_{1} \\ {s}_{2}\end{matrix} ]$$

This can be rewritten as

$${\underline{y}}_{UE 1} = [ \begin{matrix}{λ}_{1 ( U E 1 )} \cdot ( {\underline{v}}_{1 ( UE 1 )}^{H} \cdot {\underline{p}}_{1} \cdot {s}_{1} + {\underline{v}}_{2 ( UE 1 )}^{H} \cdot {\underline{p}}_{2} \cdot {s}_{2} ) \\ {λ}_{2 ( U E 1 )} \cdot ( {\underline{v}}_{2 ( UE 1 )}^{H} \cdot {\underline{p}}_{1} \cdot {s}_{1} + {\underline{v}}_{2 ( UE 1 )}^{H} \cdot {\underline{p}}_{2} \cdot {s}_{2} ) \\ {λ}_{3 ( U E 1 )} \cdot ( {\underline{v}}_{3 ( UE 1 )}^{H} \cdot {\underline{p}}_{1} \cdot {s}_{1} + {\underline{v}}_{3 ( UE 1 )}^{H} \cdot {\underline{p}}_{2} \cdot {s}_{2} )\end{matrix} ]$$

The receive data vector for UE2 is

$${\underline{y}}_{UE 2} = [ \begin{matrix}{λ}_{1 ( UE 2 )} \cdot ( {\underline{v}}_{1 ( UE 2 )}^{H} \cdot {\underline{p}}_{1} \cdot {s}_{1} + {\underline{v}}_{2 ( UE 2 )}^{H} \cdot {\underline{p}}_{2} \cdot {s}_{2} ) \\ {λ}_{2 ( UE 2 )} \cdot ( {\underline{v}}_{2 ( UE 2 )}^{H} \cdot {\underline{p}}_{1} \cdot {s}_{1} + {\underline{v}}_{2 ( UE 2 )}^{H} \cdot {\underline{p}}_{2} \cdot {s}_{2} ) \\ {λ}_{3 ( UE 2 )} \cdot ( {\underline{v}}_{3 ( UE 2 )}^{H} \cdot {\underline{p}}_{1} \cdot {s}_{1} + {\underline{v}}_{3 ( UE 2 )}^{H} \cdot {\underline{p}}_{2} \cdot {s}_{2} )\end{matrix} ]$$

Consider a simplified case where the right eigenvectors are the same for UE1 and UE2 (V_{UE1}=V_{UE2}), but the eigenvalues are different (Λ_{UE1}≠Λ_{UE2}). Assume the precoder vectors are equal to right eigenvectors, as in p₁=v₁ and p₂=v₂. The receive data vectors for UE1 and UE2 become

$${\underline{y}}_{UE 1} = [ \begin{matrix}{λ}_{1 ( UE 1 )} \cdot {s}_{1} \\ {λ}_{2 ( UE 1 )} \cdot {s}_{2} \\ 0\end{matrix} ]$$

$$and$$

$${\underline{y}}_{UE 2} = [ \begin{matrix}{λ}_{1 ( UE 2 )} \cdot {s}_{1} \\ {λ}_{2 ( UE 2 )} \cdot {s}_{2} \\ 0\end{matrix} ]$$

In this example, UE1 and UE2 decode both s₁ and s₂ successfully, but they are weighted by different eigenvalues. Each data channel is used by one UE only and ignored in the other UE depending on which UE gets the scheduling grant from the gNB.

It is possible to grant both s₁ and s₂ to the same UE to perform SU-MIMO. Alternatively, MU-MIMO can be done by granting s₁ and s₂ to different UEs. In either case, there are two layers. The UE selection for channel n can be done based on the larger of λ_{n(UE1)} and λ_{n(UE2)} under the assumption that the added interference and noise is the same at both UE1 and UE2.

In general, the right eigenvectors for UE1 and UE2 are not equal (V_{UE1}≠V_{UE2}). To be able to use MU-MIMO, two conditions must be met. The first condition is v^{H}_{n(UE1)}·p₁≈1 and v^{H}_{n(UE1)}·p₂≈0 for some right eigenvector n for UE1. It is possible to limit the search to eigenvalues larger than a chosen threshold (λ_{n(UE1)}>threshold). The second condition to be met is v^{H}_{m(UE2)}·p₁˜0 and v^{H}_{m(UE2)}·p₂˜1 for some right eigenvector m for UE2 where λ_{m(UE2)}>threshold. For a fixed multiple beam network, p₁ and \vec{p}₂ can correspond to the precoder vectors used for the predefined beam directions/polarizations. All beam/polarization pairings are tested to determine if the two MU-MIMO conditions are met for at least one beam/polarization pair.

It is often the case that the gNB has more antenna elements (Nₐₙₜ) than the UE (Mₐₙₜ). There will be more right eigenvectors than eigenvalues (Nₐₙₜ>Mₐₙₜ). The excess right eigenvectors, totaling Nₐₙₜ−Mₐₙₜ, define a null space. This is beneficial for MU-MIMO because there are more opportunities to meet the necessary conditions. For example, it is an ideal situation for MU-MIMO when a dominant right eigenvector for UE1 falls in the null space of UE2, and vice versa. A simplified view of what is occurring is that a greater number of narrow beams produces more opportunities for MU-MIMO.

MU-MIMO can have more than two layers. Each additional layer requires another condition. For example, three layers would require three conditions to be met for MU-MIMO. The first condition is v^{H}_{n(UE1)}·p₁≈1, v^{H}_{n(UE1)}·p₂≈0, and v^{H}_{n(UE1)}·p₃≈0 for some right eigenvector n for UE1. The second condition is vH_{m(UE2)}·p₁≈0, v^{H}_{m (UE2)}·p₂≈1, and v^{H}_{m(UE2)}·p₃≈0 for some right eigenvector m for UE2. The third condition is v^{H}_{k(UE3)}·p₁≈0, v^{H}_{k(UE3)}·p₂≈0, and v^{H}_{k(UE3)}·p₃≈1 for some right eigenvector k for UE3. These conditions are met if V_{UE1}=V_{UE2}=V_{UE3} and p₁, p₂, and p₃ are right eigenvectors, but can often be met using narrow beams for the precoder vectors when the right eigenvector matrices differ.

In summary, the capacity for data transfer between the gNB and a given UE is determined by the number of resource blocks allocated and the SINR. The effective BW in the capacity equation is product of the average number of resource blocks allocated over time and 12·SCS. The number of resource blocks available increases with additional MIMO layers. Beamforming increases the SINR by focusing the transmitted power towards the UE. Beamforming also reduces interference at other UEs, potentially allowing MU-MIMO.

The currently disclosed subject matter uses a Cat-A RU (non-beamforming) with a lens beamformer for beamforming within a fixed multiple beam network. The reason beamforming can be done successfully with a 4T4R Cat-A RU is that the lens beamformer is part of the channel estimation. Consider SU-MIMO under the assumption that the UE has 4 receive antennas. The presence of the lens transforms the right eigenvectors of the channel matrix. If the beams are orthogonal and the UE is positioned in the boresight direction of one beam, then the precoder matrix can be approximated as a matrix having one non-zero element in each column (each right eigenvector selects a different beam and polarization). Four potential RF channels are formed and the associated eigenvalues track the received power at the UE for each RF channel. When only one layer is selected, SU-MIMO becomes beamforming. It is also considered beamforming if two layers are selected that correspond to the same beam and different polarizations.

If the UE is positioned between the boresights of two beams, the dominant right eigenvector will be the sum of the two beams, which widens the width of the radiating pattern. If the beams are not orthogonal (large overlap), the right eigenvectors associated with lower eigenvalues will be a weighted sum of the beams due to the cross-correlation. However, the lowest eigenvalues will likely be too low to be useful as independent RF channels.

A Cat-A 8T8R RU is more interesting because it has four beams. An off-boresight UE causes the dominant right eigenvector to have a sinc function shape where the two closest beams add and the next closest beams subtract (with a lower weight). The beam width after precoding is comparable to a single beam. It is like using a sinc function to interpolate between sampled data.

An alternative to SU-MIMO processing is to perform a beam sweep. In system 1500 of FIG. 15, a beam sweep involves the scheduler 1510 allocating all resource blocks within a given slot to one active beam. The active beam directions correspond to different slots, direction/beam 1520A to slot 1 1530A, direction/beam 1520B to slot 2 1530B, direction/beam 1520C to slot 3 1530C, direction/beam 1520D to slot 4 1530D. In this manner directions in the sector are visited periodically. This has similarities to the beam sweep done during the SSB bursts except that the beams carry data instead of cell-defining signals.

A sweep of a single beam increases the power transmitted in a direction, which increases SINR and data throughput. However, the number of scheduling opportunities is reduced by a factor of 1/N_{beams}. This reduces the capacity of the gNB-UE link. The power amplifiers associated with inactive beams can be turned off for power saving, which is a beneficial property of the lens beamformer system.

The Cat-A RU is limited to 8T8R. If the lens beamformer is 16T16R, which corresponds to 8 beams, it is necessary to split the sector into two 8T8R systems. An advantage of doing so is that the split sectors have 4 beams each providing twice as many scheduling opportunities for the UE during a beam sweep. Viewed another way, two beams are swept simultaneously, but in different split sectors, doubling the throughput of the gNB.

It is also possible to transmit two beams simultaneously within a split sector. For example, beam 1 and beam 3 could be active for one slot and beam 2 and beam 4 could be active on alternating slots. If one of the active beams is null at UE1, and the other beam is null at UE2, then MU-MIMO is possible, doubling the throughput. If not, sharing of the resource blocks is necessary. However, since the two beams are driven by separate power amplifiers (for a lens beamformer) the total power radiated can double. If it assumed that the unused resource blocks in each beam have no signal, the SINR improves in each active beam, which in turn increases throughput.

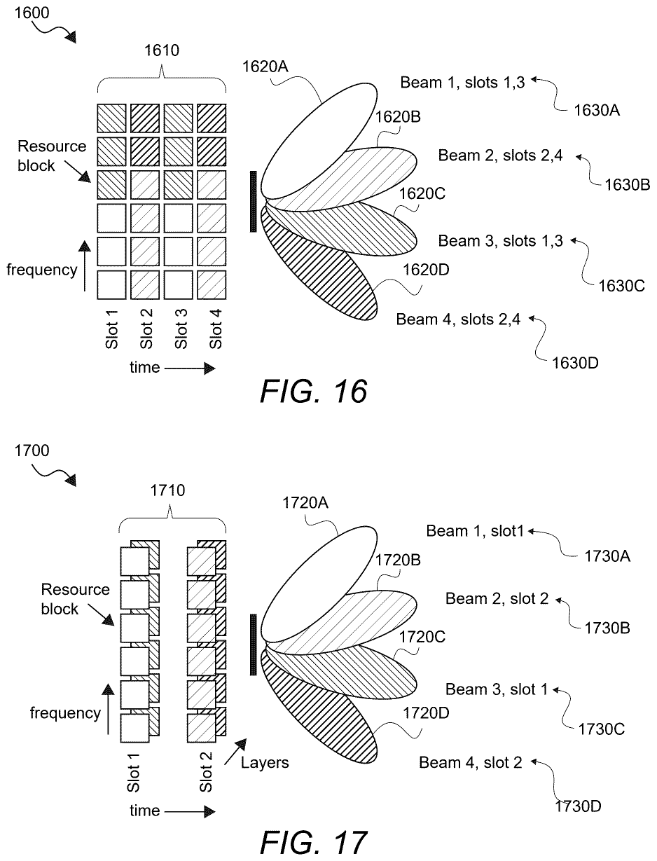

Scheduling two orthogonal beams simultaneously within a split sector provides several options. One can start with resource block sharing, shown in system 1600 of FIG. 16, which is a conservative approach. Here scheduler 1610 controls different directions of a single beam in four different beam directions, 1620A, 1620B, 1620C, 1620C, 1620D corresponding with slots 1,3 1630A, slots 2,4 1630B, slots 1,3 slots 1630C, and slots 2,4 1630D, respectively.

If a UE1 serviced by beam 1 detects sufficient signal power on the resource blocks allocated to UE2 on beam 3, then the scheduler should consider assigning both beam 1 and beam 3 to UE1 to perform SU-MIMO. If UE1 does not detect power on the resource blocks assigned to UE2, then MU-MIMO should be considered. A similar process is completed for UE2 to determine if MIMO is feasible and beneficial in term of throughput. Receiving information about the UE requires feedback, which is available to a certain degree using CSI channel reporting. However, using the UL information, such as the SRS, under the assumption of RF channel reciprocity is preferred when applicable.

In FIG. 17, scheduler 1710 simultaneously schedules two orthogonal beams using 2-layer MIMO. Beam/directions 1720A, 1720C are controlled using slot 1, and beam/directions 1720B, 1720D are controlled using slot 2.

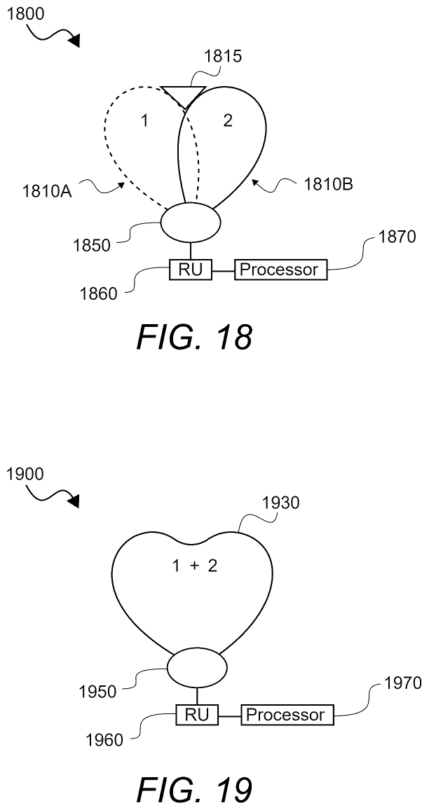

FIG. 18 depicts system 1800 having a processor 1870, RU 1850 and lens 1850, where the UE line-of-sight 1815 falls between the available beam directions 1810A, 1810B. Because the directional beam power of the main lobe decreases as the off-boresight angle increases, selecting the best beam causes the UE to receive less line-of-sight power. Such a UE is said to is said to be in a grey zone 1815, which results in reduced SINR and throughput.

FIG. 19 depicts system 1900 having a processor 1970, RU 1960, lens 1950, when, throughput for UEs is enhanced in a grey zone by transmitting the same data on neighboring beams simultaneously, which results in a broader beam width with better line-of-sight power.

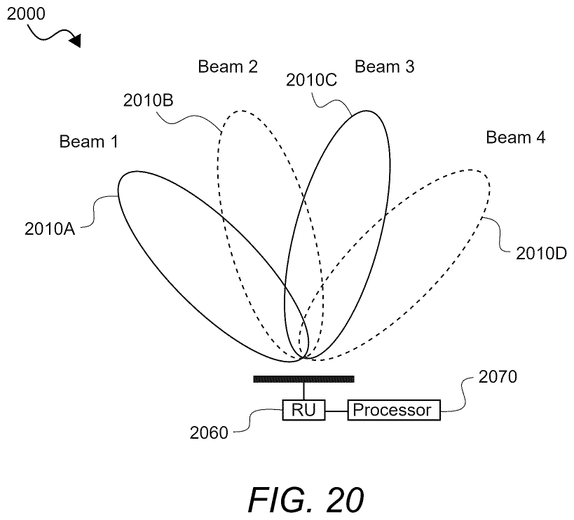

FIG. 20 depicts a preferred implementation 2000 using a 8T8R RU 2060 having 4 beams, with processor 2070 and lens 2050. Here beam 1 2110A and beam 3 2110C are orthogonal, and beams 2 2110B and 4 22110D are orthogonal. Accordingly, there are two orthogonal beam sets 2010A, 2010C and 2010B, 2010D, interlaced to create 4 beams with overlap 2010A through 2010D. Overlapping the beams reduces the severity of grey zones, improving the SINR and throughput for grey zone UEs.

The capacity of the gNB, throughput to individual UEs, and power management are important performance metrics. The gNB is designed for peak values of each metric, but the needs are dependent on the number and types of UEs in the cell as well as the proximity of the UEs to the gNB. SU-MIMO increases throughput to a UE, MU-MIMO increases the gNB capacity, and beamforming improves throughput to distant UEs. Beam sweeping within a lens beamforming system can be used for power saving because power amplifiers associated with inactive beams can be turned off. Having the ability to dynamically switch between a single beam or multi-beam sweep allows for a trade-off of capacity and power consumption that can be optimized to match the time-of-day demand. Dynamically switching between SU-MIMO and MU-MIMO allows for a trade-off between UE throughput and gNB capacity that can be optimized to match instantaneous demand.

### I. Scheduling

Scheduling resource blocks in a cell with multiple UEs is performed in the MAC, which is part of the DU. Scheduling algorithms are often proprietary and not disclosed publicly. The general approaches include proportional fair (PF), round robin (RR), and best CQI. PF allocates more resource blocks to UEs with poor channel conditions so there is less disparity in throughput between UEs. RR allocates an equal number of resource blocks to all UEs, which benefits those with favorable channel conditions. Best CQI maximizes throughput by giving priority to UEs with the high CQIs at the expense of those with low CQIs. CQI is an indicator of channel quality.

Consider the case of the downlink for an 8T8R cat-A RU with an 8T8R lens beamformer. The beam set comprises two orthogonal pairs: beams 1 and 3, and beams 2 and 4. A suitable scheduling approach based on a beam sweep of one or two active beams would be as follows.
Associate each UE with a best gNB beam based on the measured power.
For each beam, identify the high powers amongst the UEs. Those UEs become candidates for MIMO. At the minimum, these UEs should be capable of SU-MIMO using a single beam with dual polarization.
For MIMO candidates, check the power on the orthogonal beam (for example, the best and orthogonal beams are beams 1 and 3). If the UE has a high power on the orthogonal beam (for example, beam 3), consider the UE for 4×4 SU-MIMO. If the UE has a low power on the orthogonal beam (for example, beam 3), consider it for MU-MIMO.
For MU-MIMO candidates, find pairs of UEs where UE1 and UE2 have different best beams (for example, beams 1 and 3) and similar CQIs. It may be necessary to select resource blocks within specific sub-carrier ranges where the MU-MIMO condition (low power on the orthogonal beam) is most closely met.
Perform a beam sweep with one or two active beams. Give scheduling priority to UEs with MIMO resource blocks (multiple layers) and share the remaining resource blocks amongst the other UEs whose best beam is active.

MIMO processing requires that the number of receive antennas on the UE be enough to support the desired MIMO rank. The power levels are either measured by the UE and fed back to the gNB in the CSI report or inferred from the SRS measured by the gNB for TDD systems exhibiting channel reciprocity.

The above scheduling algorithm is designed to maximize the number of resource blocks available by using additional layers whenever feasible. It is also compatible with a 4T4R cat-A RU, assuming the two beams are orthogonal.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A fixed multiple beam network comprising a non-beamforming radio unit (RU) and a distributed unit (DU).

2. The apparatus of claim 1, wherein the non-beamforming radio unit (RU) is cat-A split compliant as described in the O-RAN standard.

3. The apparatus of 1, wherein the distributed unit (DU) is cat-A split compliant as described in the O-RAN standard.

4. The apparatus of 1 further comprising a lens beamformer configured to receive multiple beams from the non-beamforming radio unit (RU).

5. The apparatus of claim 1, wherein the fixed multiple beam network is based on time division duplexing (TDD).

6. The apparatus of claim 1, wherein the fixed multiple beam network is based on frequency division duplexing (FDD).

7. A method of providing an RF signal to a sector, comprising scanning the sector using a first non-beamforming radio unit (RU) and a distributed unit (DU).

8. The method of claim 7, further comprising using a single active beam to sweep an entirety of the sector.

9. The method of claim 7, further comprising using multiple active beams within the fixed multiple beam network to sweep the sector.

10. The method of claim 7, further comprising using at least a second RUs and the DU to perform synchronized beam sweeps from a base station to minimize cross-beam interference.

11. The method of claim 7, wherein the DU has a precoder matrix, and further comprising transforming the precoder matrix using a lens beamformer such that each right eigenvector selects a different beam and polarization.

12. A distributed unit (DU) having a scheduler configured to schedule resource blocks to control a multiple beam network using a lens beamformer.

13. The apparatus of claim 12, wherein the DU is configured to schedule resource blocks to optimize data throughput.

14. The apparatus of claim 12, wherein the DU is configured to schedule resource blocks to dynamically conform to time-of-day demands.

15. The apparatus of claim 12, wherein the scheduler grants resource blocks in a multiple UE environment to maximize the use of MIMO layers.

16. The apparatus of claim 12, wherein the DU associates each UE with a best gNB beam based on the measured power; selects the high powers amongst the UEs for each beam as MIMO candidates; checks the powers of candidate UEs on the orthogonal beam; selects UEs with a high power on the orthogonal beam for high rank SU-MIMO.

17. The apparatus of claim 16, wherein where a beam sweep is performed with one or two active beams giving scheduling priority to UEs with MIMO resource blocks (multiple layers) and sharing the remaining resource blocks amongst the other UEs whose best beam is active.

18. The apparatus of claim 12, wherein the DU associates each UE with a best gNB beam based on the measured power; selects the high powers amongst the UEs for each beam as MIMO candidates; checks the powers of candidate UEs on the orthogonal beam; selects UEs with low power on the orthogonal beam for MU-MIMO; finds pairs from the selected UEs where UE1 and UE2 have different best beams and similar CQIs.

19. The apparatus of claim 18, wherein a beam sweep is performed with one or two active beams giving scheduling priority to UEs with MIMO resource blocks (multiple layers) and sharing the remaining resource blocks amongst the other UEs whose best beam is active.
